(19) United States
(12) Patent Application Publication
(10) Pub. No.: US 2025/0356153 A1
(43) Pub. Date: Nov. 20, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Hiroyuki Okamoto, Kanagawa (JP)

(21) Appl. No.: 19/208,698

(22) Filed: May 15, 2025

(30) Foreign Application Priority Data
May 20, 2024 (JP) 2024-081915

(51) Int. Cl. G06K 15/02; G06F 3/12

(52) U.S. Cl. CPC G06K 15/1823; G06F 3/1219; G06F 3/1239

(57) ABSTRACT

The use state of printing material predefined in a subscription service for which a user is under contract is to be grasped. An information processing apparatus, which is an apparatus for providing a subscription service of an image forming apparatus to a user, obtains information indicating the number of sheets on which the image forming apparatus has performed image formation during a predetermined period and a use amount of printing material required for the image formation, derives a use amount of the printing material per predetermined number of sheets, based on the obtained information, and causes a client terminal used by the user to output UI screen data for displaying the derived use amount of the printing material per predetermined number of sheets and an upper limit use amount of the printing material per predetermined number of sheets under a contract for the subscription service.

### BACKGROUND

### Field

The present disclosure relates to an information processing apparatus, a control method of an information processing apparatus, and a storage medium.

### Description of the Related Art

In recent years, as a form of using an image forming apparatus such as a printer and a multifunction peripheral, there is a subscription contract in which a predetermined flat rate fee is paid, so that an image forming apparatus that performs image formation and recording material used for the image formation can be used for a predetermined period. In a subscription contract, there may be a predetermined upper limit use amount (coverage rate) of recording material per sheet of a predetermined size.

Regarding technologies for issuing a warning related to the remaining amount of recording material, Japanese Patent Laid-Open No. 2015-39782 discloses a technology in which the remaining amount of recording material after image formation is estimated based on the current remaining amount of recording material and the use amount of recording material used in the image formation, so that a warning is issued in a case where the estimated remaining amount is smaller than a threshold value.

### SUMMARY

The information processing apparatus according to an embodiment of the present disclosure is an information processing apparatus for providing a subscription service of an image forming apparatus to a user, and the information processing apparatus includes: at least one memory that stores instructions; and at least one processor that executes the instructions to: obtain information indicating the number of sheets on which the image forming apparatus has performed image formation during a predetermined period and a use amount of printing material required for the image formation; derive a use amount of the printing material per predetermined number of sheets, based on the obtained information; and cause a client terminal used by the user to output UI screen data for displaying the derived use amount of the printing material per predetermined number of sheets and an upper limit use amount of the printing material per predetermined number of sheets under a contract for the subscription service.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of the overall configuration of a system;

FIG. 2A and FIG. 2B are diagrams illustrating examples of the hardware configuration of each apparatus constituting the system;

FIG. 3 is a diagram illustrating an example of the functional configuration of each apparatus constituting the system;

FIG. 4 is a diagram illustrating an example of a screen of a client terminal;

FIG. 5 is a sequence diagram illustrating a flow of processing among apparatuses;

FIG. 6 is a flowchart illustrating a flow of a statistic information generation process;

FIG. 7A to FIG. 7C are diagrams illustrating examples of a screen of the client terminal;

FIG. 8A and FIG. 8B are diagrams illustrating examples of a screen of the client terminal;

FIG. 9 is a sequence diagram illustrating a flow of processing among apparatuses;

FIG. 10 is a diagram illustrating an example of a screen of the client terminal;

FIG. 11 is a sequence diagram illustrating a flow of processing among apparatuses; and

FIG. 12 is a flowchart illustrating a flow of a service plan change determination process.

### DESCRIPTION OF THE EMBODIMENTS

With the above-mentioned technology of Japanese Patent Laid-Open No. 2015-39782, although the remaining amount of recording material being low is indicated by the warning, it does not allow the user to grasp the use state of recording material in light of the contract contents of the subscription service for which the user is under contract.

Hereinafter, with reference to the accompanying drawings, a description is given about embodiments of the technology of the present disclosure. Note that the following embodiments are not intended to limit the technology of the present disclosure related to the scope of the patent claims. Not all combinations of the features described in the embodiments are essential to the solutions provided by the technology of the present disclosure, and multiple features may be combined in any desired manner. Note that the same reference sign is given for descriptions of the same configuration. Further, each process (step) in flowcharts is denoted with the letter “S” at the beginning.

### First Embodiment

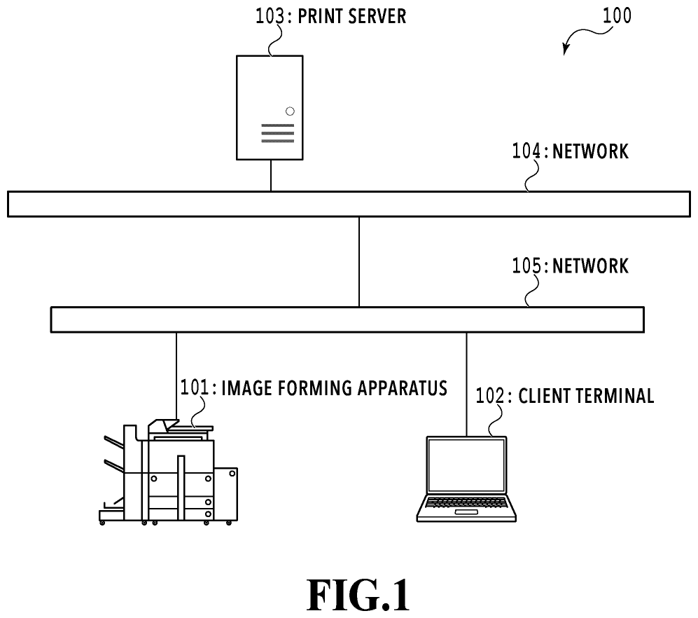

FIG. 1 is a diagram illustrating an example of the configuration of an information processing system according to the present embodiment. The information processing system 100 according to the present embodiment includes an image forming apparatus 101, a client terminal 102, and a print server 103, and each of the apparatuses 101 to 103 is connected to networks 104 to 105.

The networks 104 and 105 are what is termed as communication networks, which are implemented by, for example, a LAN or a WAN (e.g., the Internet), a telephone line, a dedicated digital line, an ATM or frame relay line, a cable television line, a wireless line for data broadcasting, or the like. The networks 104 and 105 may be any networks that are capable of transmitting and receiving data. In the present embodiment, it is assumed that the network 104 is the Internet, and the network 105 is a local area network (LAN).

The network 105 is a LAN to which the image forming apparatus 101 and the client terminal 102 are connected. The image forming apparatus 101, the client terminal 102, and the print server 103 communicate with each other via a LAN. That is, the image forming apparatus 101 and the client terminal 102 can access the network 104 via the network 105 to access the print server 103.

The image forming apparatus 101 is a multifunction peripheral or a printer that has a copy function, a scanner function, a fax transmission function, and the like in addition to a printing function.

The client terminal 102 is an apparatus that processes data, such as a personal computer or a mobile terminal, for using cloud services. Specifically, the client terminal 102 is a computer used by a user of the image forming apparatus 101 to transmit a print job to the image forming apparatus 101 or to transmit a print instruction to the print server 103.

The print server 103 provides a service for carrying out a print instruction and the like to a device registered in the contract information of the user's contract. Further, in a case of receiving data from a device registered in the registration information, the print server 103 performs various processes corresponding to the received data.

Note that the print server 103 is made available on the Internet as a cloud service in which a plurality of servers is each provided for redundancy. Further, the functions of each service may be implemented by a single server or a single virtual server, or may be implemented by multiple servers or multiple virtual servers. Alternatively, multiple virtual servers may be running on a single server.

The print server 103 is a server that provides a print service, and provides functions related to contract management for the print service and printing. The print server 103 holds contract information of each user's contract. In the present embodiment, the user registers in the print server 103 via the client terminal 102 a service plan, user information, and device information which is information about the image forming apparatus 101, and thus the print server 103 holds the contract information. That is, the print server 103 is an apparatus for providing a user with a subscription service in which the image forming apparatus 101 and recording materials used for the image formation can be used at a flat rate.

### (Hardware Configuration of the Image Forming Apparatus)

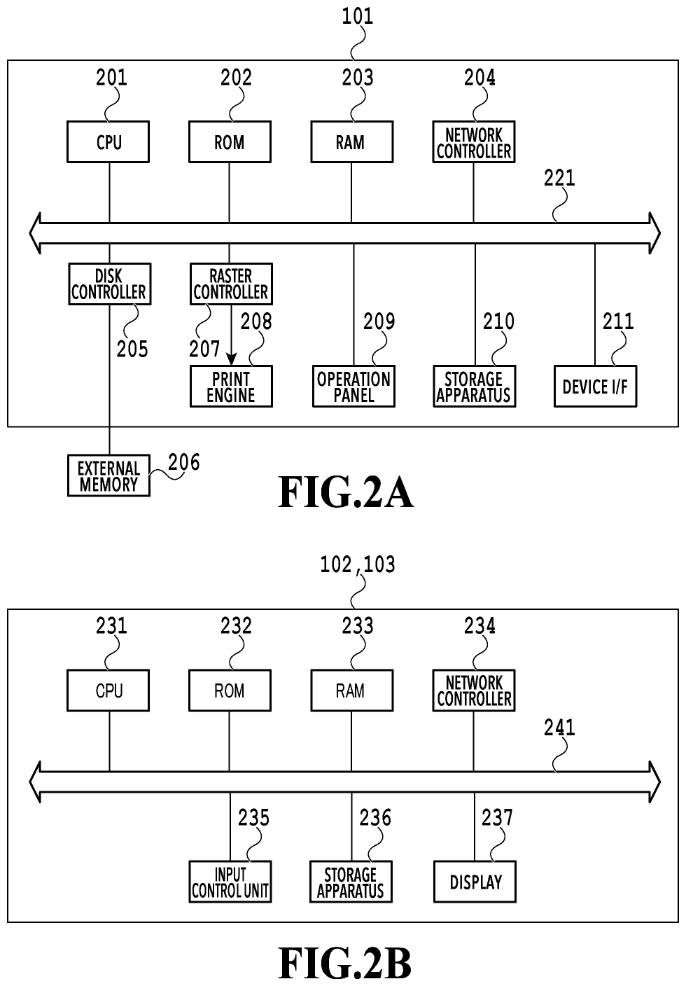

FIG. 2A is a diagram illustrating an example of the hardware configuration of the image forming apparatus 101. The image forming apparatus 101 includes a CPU 201, a ROM 202, a RAM 203, a network controller 204, a disk controller (DKC) 205, a raster controller 207, and a print engine 208. The image forming apparatus 101 further includes an operation panel 209, a storage apparatus 210, and a device I/F 211. Each of the devices 201 to 211 is connected to a system bus 221 so as to be capable of mutual data transmission and reception.

The CPU 201 preforms overall control of the image forming apparatus 101. Specifically, the CPU 201 comprehensively controls the access to various devices connected to the system bus 221, based on control programs, resource data (resource information), etc. The control programs, resource data (resource information), etc., are stored in the ROM 202 or an external memory 206 connected via the DKC 205. The RAM 203 functions as a main memory, work area, etc., of the CPU 201. The memory capacity of the RAM 203 may be expandable by an optional RAM connected to an expansion port (not illustrated in the drawings). The storage apparatus 210 is an external storage apparatus that functions as a large volume memory, and stores programs for the later-described processing units 311 to 316 according to the present embodiment. The operation panel (the operation unit) 209 is a device that displays a screen and accepts a user's operating instruction via the screen. On the operation panel 209, buttons for setting the operation mode or the like of the image forming apparatus 101, displaying the operation condition of the image forming apparatus 101, and providing an operation such as a copying instruction, and a display unit such as a liquid crystal panel may be arranged. The network controller 204 is a device for communicating data with external apparatuses, and is, for example, a network interface card (NIC). The print engine 208 is a device for printing on a recording medium. The print engine 208 may perform printing using known printing technologies, such as electrophotography (a laser-beam method), an inkjet method, and a sublimation (thermal transfer) method. The raster controller 207 is a controller that converts print data described in a language such as PDL (Page Description Language) or PDF (Portable Document Format) into image data. The device I/F 211 is an interface for connecting to an external device via a USB (Universal Serial Bus) or the like.

### (Hardware Configuration of the Client Terminal and the Print Server)

FIG. 2B is a diagram illustrating an example of the hardware configuration of the client terminal 102 and the print server 103. Since the hardware configuration of the print server 103 may be the same as that of the client terminal 102, duplicated descriptions are omitted. The print server 103 may be a single device or a system composed of multiple devices. Further, the print server 103 may be a system in which processing is performed by the multiple devices connected to each other via a network such as a LAN or WAN (Wide Area Network). The client terminal 102 and the print server 103 may each include all of the components illustrated in FIG. 2B. Alternatively, some of the components in FIG. 2B may be omitted, or the client terminal 102 and the print server 103 may each have additional components.

The client terminal 102 and the print server 103 each include a CPU 231, a ROM 232, a RAM 233, a network controller 234, an input control unit 235, a storage apparatus 236, and a display 237. Each of the devices 231 to 237 is connected to a system bus 241 so as to be capable of mutual data transmission and reception.

The CPU 231 is a processing circuit that controls the entire apparatus in which the CPU 231 is installed. For example, the CPU 231 executes application programs, an operating system, and the like stored in the storage apparatus 236. Further, the CPU 231 performs control of temporarily storing information, files, and the like used for the execution of the programs in the RAM 233. The ROM 232 is a memory that stores programs such as a basic I/O (Input/Output) program and various data. The RAM 233 is a temporary storage memory that functions as a main memory, a work area, etc., for the CPU 231. The network controller 234 is a device for communicating data with external apparatuses, and is, for example, a network interface card (NIC).

The input control unit 235 is a device that controls input to the apparatus in which the input control unit 235 is installed. The client terminal 102 and the print server 103 each exchange data with an external apparatus via the input control unit 235. The storage apparatus 236 is one of the external storage apparatuses, and functions as a large volume memory. The storage apparatus 236 stores application programs, an operating system (OS), and the like. The display 237 is a display apparatus that displays program results, information required for input operations, and the like. Further, the display 237 may have a function of accepting user's operating instructions via a screen such as a touch panel.

### (Functional Configuration of the System)

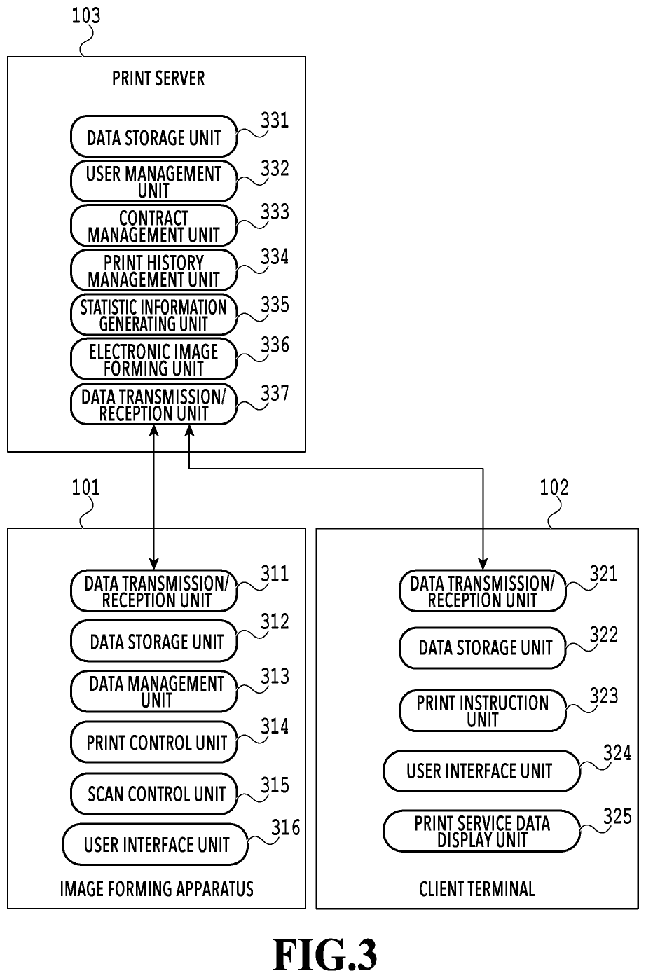

FIG. 3 is a diagram illustrating an example of the functional configuration (the software configuration) of each apparatus constituting the information processing apparatus according to the present embodiment. The software configurations for the functions related to the present embodiment excerpted from the image forming apparatus 101, the client terminal 102, and the print server 103 are described. Note that the software modules of the image forming apparatus 101 are stored in the storage apparatus 210, and are loaded into the RAM 203 and executed by the CPU 201 as described above. The software modules of the client terminal 102 and the print server 103 are each stored in the storage apparatus 236 of each apparatus, and are implemented by the CPU 231 loading the modules into the RAM 233 and executing them as described above. Note that each functional unit included in each of the image forming apparatus 101, the client terminal 102, and the print server 103 may take on part of the functions of the other functional units.

The image forming apparatus 101 includes the data transmission/reception unit 311, the data storage unit 312, the data management unit 313, the print control unit 314, the scan control unit 315, and the user interface unit 316. The data transmission/reception unit 311 transmits and receives data to and from the client terminal 102 and the print server 103. For example, the data transmission/reception unit 311 transmits print result information of the image forming apparatus 101 to the print server 103 and receives data such as a print instruction from the print server 103.

The data storage unit 312 saves data input by the user, device information, and the like. The data management unit 313 manages data, such as saving data in the data storage unit 312, updating and deleting saved data. The print control unit 314 controls printing. The scan control unit 315 controls scanning. The user interface unit 316 accepts input from the user. In accordance with the input contents accepted by the user interface unit 316, printing by the print control unit 314, scanning by the scan control unit 315, etc., are performed.

The client terminal 102 includes a data transmission/reception unit 321, a data storage unit 322, a print instruction unit 323, a user interface unit 324, and a print service data display unit 325. The data transmission/reception unit 321 transmits and receives data to and from the image forming apparatus 101 and the print server 103. For example, the data transmission/reception unit 321 transmits data such as a print instruction to the image forming apparatus 101 and receives data such as scan data from the image forming apparatus 101. Further, the data transmission/reception unit 321 transmits data such as an information registration instruction and a print instruction to the print server 103, and receives data such as contract information and print history information from the print server 103.

The data storage unit 322 saves data related to the image forming apparatus 101, user information related to the print server 103, and the like. The print instruction unit 323 issues a print instruction via the print server 103 or directly to the image forming apparatus 101. The print instruction unit 323 may be a client application for the print server 103 or a printer driver.

The user interface unit 324 accepts input from the user. In accordance with the input contents accepted by the user interface unit 324, instructions to the image forming apparatus 101, instructions to the print server 103, etc., are issued. The print service data display unit 325 displays data such as UI data received from the print server 103. The print service data display unit 325 may be a browser or a client application for the print server 103.

The print server 103 includes a data storage unit 331, a user management unit 332, a contract management unit 333, a print history management unit 334, a statistic information generating unit 335, an electronic image forming unit 336, and a data transmission/reception unit 337.

The data storage unit 331 saves data related to a contract registered for a print service provided by the print server 103, data related to a user, data related to a device, a print history, etc.

The user management unit 332 manages user data, such as saving data related to a user who uses a print service provided by the print server 103 in the data storage unit 331, updating and deleting the saved user data, etc. Table 1 below shows an example of data managed by the user management unit 332.

TABLE 1
User Management Table

| User ID | Password | Login Status | Login Expiration Date |
|---|---|---|---|
| userA | ********** | on | 2022 Dec. 31 0:00 |
| userB | ********** | on | 2022 Dec. 31 0:00 |
| userC | ********** | off | |

The user ID column records an ID that uniquely identifies a user. The password column records a password for the basic authentication used by the user to log in with the user ID. The user management unit 332 compares the combination of the user ID and password included in a login request from the client terminal 102 with the combinations of the user ID and passwords managed in the user management table of Table 1. Further, as a result of the comparison, if a matching combination is present in the user information managed by the user management unit 332, the user management unit 332 returns a successful login result to each client terminal. The login status column records the login status of a user. In the login status column, “on” indicates a logged-in status, and “off” indicates a logged-out status. The login expiration date column indicates the expiration date of the authentication status of a logged-in user.

The contract management unit 333 manages the service plans offered in a print service provided by the print server 103, such as saving a service plan in the data storage unit 331, updating and deleting a saved service plan, etc. Further, the contract management unit 333 manages the contract status indicating which service plan a user or device is under contract for. Table 2 below shows an example of a service plan managed by the contract management unit 333.

TABLE 2
Service Plan Management Table

| | | | | | Upper | |
|---|---|---|---|---|---|---|
| | | | | | Limit | |
| | | Coverage | Billing | Contract | Number of | |
| Plan ID | Color | Rate | Interval | Period | Sheets | Fee |
| planA | Color | 30% | 1 month | 1 year | 100 sheets | 20 USD |
| planB | Monochrome | 10% | 1 month | 1 year | 100 sheets | 10 USD |
| planC | Color | 60% | 1 month | 1 year | 100 sheets | 25 USD |
| planD | Monochrome | 30% | 1 month | 1 year | 100 sheets | 15 USD |
| planE | Color | 50% | 1 year | 1 year | | 0.7 USD/sheet |
| planF | Color | 30% | 1 month | 1 month | 100 sheets | 20 USD (up to |
| | | | | | | the limit) |
| | | | | | | 0.7 USD/sheet |
| | | | | | | (excess |
| | | | | | | amount) |

The plan ID column records an ID that uniquely identifies a service plan provided by a print service. The color column records the print type. The color column indicates whether the printing type is color or monochrome in the service plan.

The coverage rate column records the upper limit of the coverage rate predefined in the service plan. The upper limit value of the coverage rate may be expressed based on a print range (an image forming range) or a use amount of printing material (recording material). If expressed based on a print range, the upper limit value of the coverage rate indicates the upper limit of the ratio of the size of the printable range using printing material to the size of the entire printable range of single printing paper (sheet) of a predetermined size. If expressed based on a use amount of printing material, the upper limit value of the coverage rate indicates the upper limit of the ratio of the use amount of printing material that can be used for printing to the use amount of printing material that would be used if printing were performed on the entire printable range of single printing paper (sheet) of a predetermined size. That is, it can also be said that the upper limit of the coverage rate indicates the upper limit use amount of printing material per predetermined number of sheets of a predetermined size.

For example, in a case where the image forming apparatus is an apparatus that performs printing using each of the CMYK toners as printing material, and the type in the color column is “Color”, the upper limit value of the coverage rate predefined in the service plan is as follows. That is, if expressed based on a print range, the upper limit value of the coverage rate indicates the upper limit of the ratio of the total print range that is printable using each of the CMYK toners to the total print range that would be covered if printing were performed on the entire print range of single printing paper using each of the CMYK toners. If expressed based on a use amount of printing material, the upper limit value of the coverage rate indicates the upper limit of the ratio of the total use amount of each of the CMYK toners that can be used for printing to the total use amount of each of the CMYK toners that would be used if printing were performed on the entire print range of single printing paper.

Further, in a case where the image forming apparatus is an apparatus that performs printing using each of the CMYK toners as printing material, and the type in the color column is “Monochrome”, the upper limit value of the coverage rate predefined in the service plan is as follows. That is, if expressed based on a print range, the upper limit value of the coverage rate indicates the upper limit of the ratio of the total print range that is printable using the K toner to the total print range that would be covered if the K toner were used on the entire print range of single printing paper. If expressed based on a use amount of printing material, the upper limit value of the coverage rate indicates the upper limit of the ratio of the total use amount of the K toner that can be used to the total use amount of the K toner that would be used if the K toner were used on the entire print range of single printing paper.

The billing interval column records the interval at which billing occurs. In the billing interval column, for example, 1 month or 1 year is recorded. For example, in a case where 1 month is recorded as the billing interval, it indicates that billing of the fee occurs every month. In a case where 1 year is recorded as the billing interval, it indicates that billing of the fee occurs annually. The contract period column records the unit of time for which a user signs up for the service plan. In the contract period column, for example, 1 month of 1 year is recorded. For example, in a case where 1 year is recorded as the contract period, it indicates that the service plan contracted is renewed on a yearly basis. In a case where 1 month is recorded as the contract period, it indicates that the service plan contracted is renewed on a monthly basis. As in the example above, the billing interval and contract period may differ.

The upper limit number of sheets column records the upper limit number of sheets that can be printed during the period of the billing interval. A blank indicates that there is no upper limit. The fee column records the fee for the service plan charged per billing interval. For example, for a service plan with plan ID planA in Table 2, it indicates that a fixed amount of 20 USD per month is billed. Further, for the service plan of planE, it indicates that a variable amount of 0.7 USD per sheet is billed. Note that the fee may be set by combining a fixed amount and variable amount as in planF, where 20 USD is billed if the number of printed sheets in the upper limit number of sheets column is not exceeded, and 0.7 USD per sheet is additionally billed if it is exceeded.

Further, Table 3 below shows an example of the contract statuses managed by the contract management unit 333.

TABLE 3
Contract Status Management Table

| Contract ID | User ID | Plan ID | Device ID | Start Date | Renewal Date | Closing Date |
|---|---|---|---|---|---|---|
| contractA | userA | planA | DeviceA | 2023 Jan. 1 | 2024 Jan. 1 | 2023 Feb. 1 |
| contractB | userB | planB | DeviceB | 2023 Jan. 15 | 2024 Jan. 15 | 2023 Feb. 15 |
| contractC | userC | planE | DeviceC | 2023 Jan. 20 | 2023 Feb. 20 | 2023 Feb. 20 |

The contract ID column records an ID that uniquely identifies a contract. The user ID column records an ID that uniquely identifies a user. In the user ID column of Table 3, the same user ID as the user ID registered in the user ID column of Table 1 is registered. The plan ID column records an ID that uniquely identifies a service plan. In the plan ID column of Table 3, the same plan ID as the plan ID registered in the plan ID column of Table 2 is registered. The device ID column records an ID that uniquely identifies a device, and indicates the device ID of a device used in the contracted service plan.

The start date column records the date that a user signs up to start a service plan. The renewal date column records the end date of the period for which the user is under contract for the service plan, and indicates the renewal date on which the contract is continued or the continuation is terminated. The closing date column records the date on which the next fee will be billed.

The print history management unit 334 manages the print history, such as saving the print results received from the image forming apparatus 101 in the data storage unit 331 and creating a print history based on the saved print results. Table 4 below shows an example of the print history managed by the print history management unit 334.

TABLE 4
Print History Management Table

| | | | | Coverage | |
|---|---|---|---|---|---|
| Device ID | Document | Page | Color | Rate | Date and Time |
| DeviceA | ABC.pdf | 1/3 | Color | 10% | 2023 Jan. 2 12:00 |
| DeviceA | ABC.pdf | 2/3 | Color | 5% | 2023 Jan. 3 12:00 |
| DeviceA | ABC.pdf | 3/3 | Color | 15% | 2023 Jan. 4 12:00 |
| DeviceA | XYZ.pptx | 1/1 | Color | 30% | 2023 Jan. 5 18:00 |
| DeviceB | QWE.pdf | 1/1 | Monochrome | 20% | 2023 Jan. 20 19:00 |

The device ID column records an ID that uniquely identifies a device, and indicates the device that has performed printing. The document column records the name of a printed document. The page column indicates the page number of the printed page of the document in the numerator, and indicates the total number of pages of the document in the denominator. The color column indicates whether the print type of the printing was color or monochrome.

The coverage rate indicates the coverage rate of printing material used for single printing paper of a predetermined size. The coverage rate may be expressed based on a print range or a use amount of printing material. If expressed based on a print range, the coverage rate indicates the ratio of the size of the printed range using printing material to the size of the entire printable range of single printing paper. If expressed based on a use amount of printing material, the coverage rate indicates the ratio of the use amount of printing material used for printing of the given page to the use amount of printing material that would be used if printing were performed on the entire printable range of single printing paper.

The date and time column indicates the date and time at which the printing was performed.

The statistic information generating unit 335 generates statistic information related to a user's contract and printing, based on the information managed by the user management unit 332, the contract management unit 333, and the print history management unit 334, and generates a UI for displaying the above-mentioned statistic information. For example, statistic information that indicates whether printing is being performed exceeding the upper limit coverage rate, which is predefined in the service plan for which the user is under contract, is generated. For the user with user ID userA in the user management table of Table 1, contract information of the device with device ID DeviceA under contract for the service plan with plan ID planA is obtained from the contract status management table of Table 3. Regarding the device with the device ID DeviceA, the print history management table of Table 4 shows that the use amount of printing material (coverage rate) per predetermined number of sheets (one sheet) for each print is as follows. That is, the coverage rate is 10% on 1/3 page of ABC.pdf, 5% on 2/3 page of ABC.pdf, 15% on 3/3 page of ABC.pdf, and 30% on 1/1 page of XYZ.ppptx. Since the total coverage rate for the four pages is 10%+5%+15%+30%=60%, the average coverage rate per page is calculated to be 60%/4=15%. Further, regarding the service plan with the plan ID planA, a prescribed upper limit coverage rate of 30% is obtained from the service plan management table of Table 2. From the calculated average coverage rate and the obtained upper limit coverage rate, statistic information indicating that the user with user ID userA has not performed printing exceeding the upper limit coverage rate predefined in the service plan can be generated.

Further, the statistic information generating unit 335 manages glossaries used to create a UI that displays generated statistic information. Table 5 below shows an example of glossaries managed by the statistic information generating unit 335.

TABLE 5
Glossary Table

| Glossary ID | Language | Glossary | Condition |
|---|---|---|---|
| glossaryA | ja | Within the prescribed | Average coverage rate during the |
| | | value of the plan | contract period < Upper limit |
| | | | coverage rate*0.8 |
| glossaryB | ja | About to exceed the | Upper limit coverage rate*0.8 ≤ |
| | | prescribed value of the | Average coverage rate during the |
| | | plan | contract period ≤ Upper limit |
| | | | Coverage Rate |
| glossaryC | ja | Above the prescribed | Upper limit coverage rate < |
| | | value of the plan | Average coverage rate during the |
| | | | contract period |

Table 5 shows, as an example, the three patterns of glossaries, each corresponding to a relationship between a use amount of printing material per predetermined number of sheets and a predefined upper limit coverage rate (a threshold value). Specifically, in a case where the average coverage rate during the contract period is below a value obtained by multiplying the predefined upper limit coverage rate (the threshold value) by a predetermined rate, the following message is to be displayed. That is, a message indicating that the average coverage rate (the use amount of recording material) during the contract period is within the predefined upper limit coverage rate (within the upper limit use amount of recording material) is to be displayed. In a case where the average coverage rate during the contract period is equal to or above the value obtained by multiplying the predefined upper limit coverage rate by the predetermined rate and, in addition, is equal to or below the predefined upper limit coverage rage, the following message is to be displayed. That is, a message indicating that the average coverage rate during the contract period is about to exceed the predefined upper limit coverage rate is to be displayed. In a case where the average coverage rate during the contract period has exceeded the predefined upper limit coverage rage, a message indicating that the average coverage rate during the contract period has exceeded the predefined upper limit coverage rate is to be displayed. The glossary ID column records an ID that uniquely identifies a glossary used by the statistic information generating unit 335. The language column records the language that is used in the country where the subscription service is provided and used for the glossary. The language column in Table 5 indicates that Japanese (ja) is used. In the language column, a language code is set as an example. The glossary column records sentences and terms to be displayed in an UI. The condition column records a condition for selecting a glossary, so that a glossary with a condition that is met by the statistic information generated by the statistic information generating unit 335 is selected. For example, in a case where the statistic information generated by the statistic information generating unit 335 indicates that the average coverage rate during the contract period is 15% and the upper limit coverage rate is 30%, the condition for glossaryA is met, and thus glossaryA is selected. Further, although the value obtained by multiplying the upper limit coverage rate by 0.8 is set as one of the reference values of the condition, this value is not limited to 0.8 and may be any value other than 0.8.

Although the conditions used in Table 5 are based on the average coverage rate during the contract period, it is also possible to use conditions based on the average coverage rate during a most recent period rather than the entire contract period, or use conditions based on a combination of the average coverage rates during the entire contract period and a most recent period. Table 6 below shows an example of a glossary table including conditions based on a combination of the average coverage rates during the entire contract period and a most recent period (a predetermined period in the past).

TABLE 6
Glossary Table

| Glossary ID | Language | Glossary | Condition |
|---|---|---|---|
| glossaryA′ | ja | Within the | Average coverage rate during the contract |
| | | prescribed value of | period < Upper limit coverage rate*0.8 |
| | | the plan | and |
| | | | Average coverage rate for the past two |
| | | | months < Upper limit coverage rate*0.8 |
| glossaryB′ | ja | About to exceed | (Upper limit coverage rate*0.8 ≤ Average |
| | | the prescribed | coverage rate during the contract period ≤ |
| | | value of the plan | Upper limit coverage) |
| | | | or |
| | | | (Average coverage rate during the contract |
| | | | period < Upper limit coverage rate*0.8 |
| | | | and |
| | | | Upper limit coverage rate*0.8 ≤ Average |
| | | | coverage rate for the past two months) |
| glossaryC′ | ja | Above the | Upper limit coverage rate < Average |
| | | prescribed value of | coverage rate during the contract period |
| | | the plan | |

The definition of each column in Table 6 is the same as in the description of Table 5. In Table 6, although two months is set as the most recent period, this period is not limited to two months and may be any desired period other than two months. The case in which the statistic information generated by the statistic information generating unit 335 indicates that the average coverage rate during the contract period is 15%, the average coverage rate during the past two months is 25%, and the upper limit coverage rate is 30% is taken as an example for the sake of description. In the case of Table 5, the condition of glossaryA is met, and thus the text “Within the prescribed value of the plan” is displayed on the UI. However, in the case of Table 6, the condition of glossaryB′ is met, and thus the warning text “About to exceed the prescribed value of the plan” is displayed on the UI. As in the above-described examples, it is also possible to generate statistic information according to not only the entire contract period but also a most recent trend, and display the statistic information on the UI.

In a case where a print instruction is issued from the print server 103 to the image forming apparatus 101, the electronic image forming unit 336 creates electronic data of a print job to be transmitted as the print instruction. By transmitting the electronic data to the image forming apparatus 101, the image forming apparatus 101 executes printing. The data transmission/reception unit 337 transmits data such as a print instruction to the image forming apparatus 101 and receives data such as operation data from the image forming apparatus 101. Further, the data transmission/reception unit 337 receives data such as an information registration instruction or a print instruction from the client terminal 102, and transmits data such as statistic information generated by the statistic information generating unit 335 to the client terminal 102.

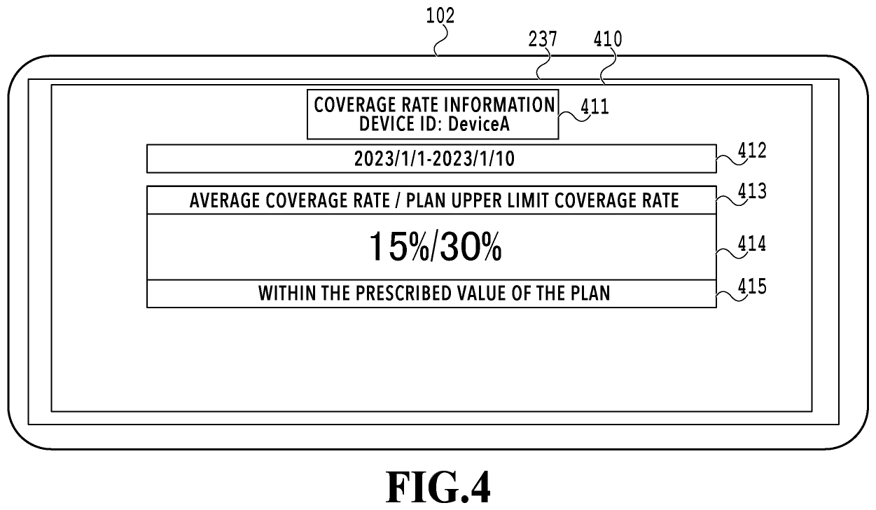

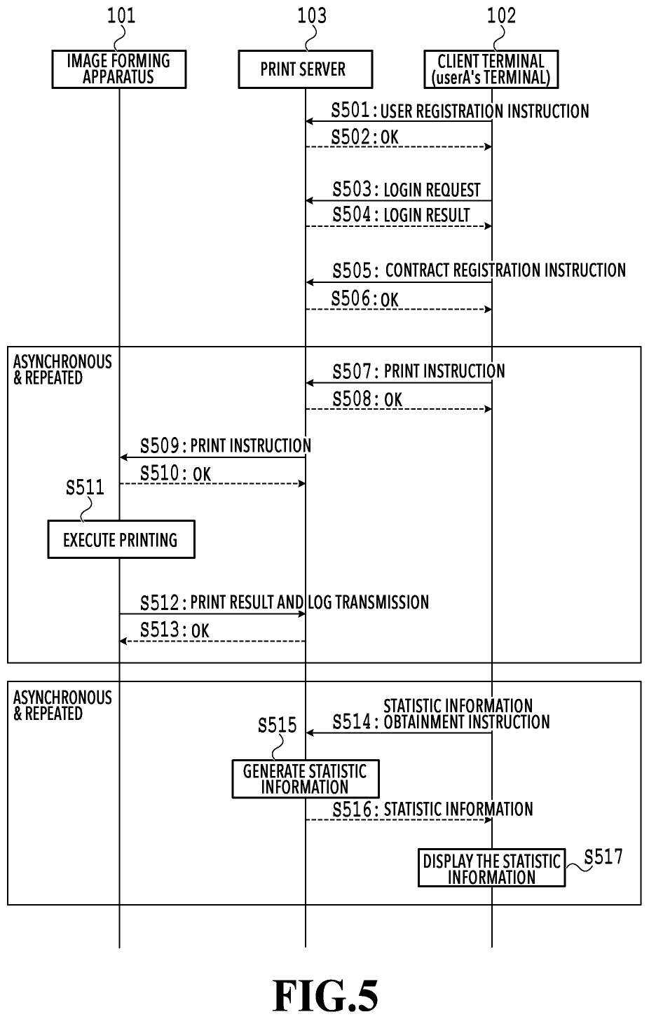

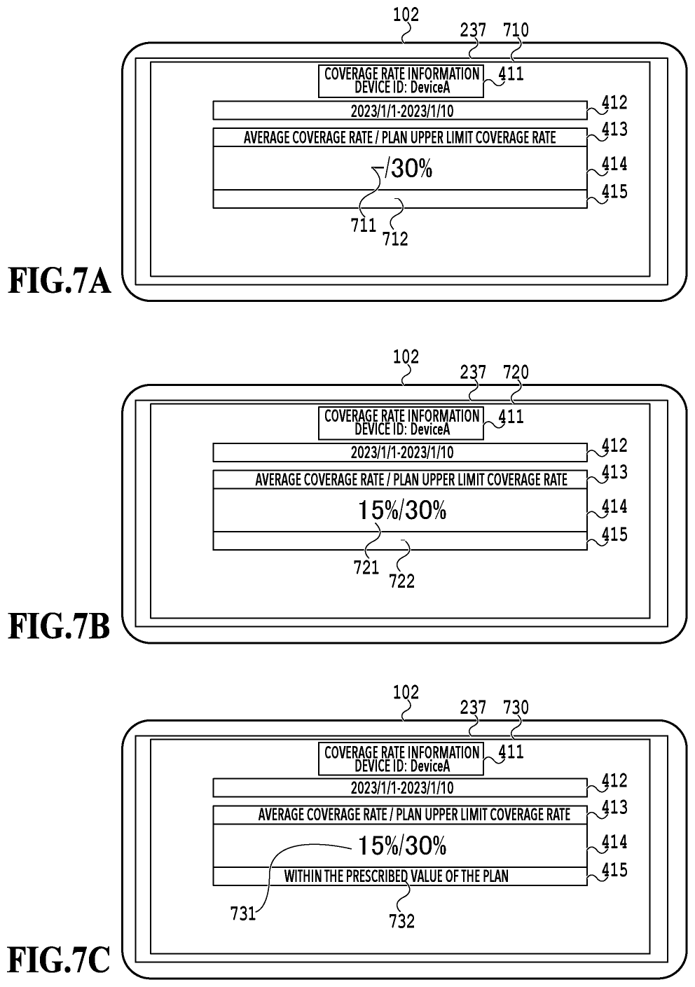

With reference to FIG. 4, FIG. 5, and FIG. 7A to FIG. 7C, a description is given of a method used in an information processing apparatus and program, which is an object of the present disclosure, to notify a user of the average coverage rate of printed materials printed by the user together with the upper limit value of the coverage rate predefined in the print service. In the present embodiment, it is assumed that the user operating the client terminal 102 is the user of userA in the user ID column of Tables 1 and 3 described above. UserA described above is a user who uses the image forming apparatus 101, and the image forming apparatus 101 is assumed to be a device of DeviceA in the device ID column of Tables 3 and 4 described above. Further, it is assumed that userA is under contract for a service plan with plan ID planA in Tables 2 and 3 described above, and DeviceA described above is registered as the device to be used.

(UI Screen that Displays Coverage Rate Information)

FIG. 4 is a diagram illustrating an example of a UI screen that displays coverage rate information. The UI screen 410 is displayed on the display 237 of the client terminal 102 used by userA. The UI screen 410 is generated by the statistic information generating unit 335 of the print server 103 according to the present embodiment. The UI screen 410 is displayed on the print service data display unit 325. Note that the UI screen 410 (the display 237) displays an example of a dashboard-type UI provided by the print server 103 in the present embodiment. That is, it can also be said that the statistic information generating unit 335 generates UI screen data for displaying the coverage rate and the upper limit use amount of recording material per predetermined number of sheets under the contract for the subscription service (the plan upper limit coverage rate), and outputs the UI screen data to the client terminal 102.

The UI screen 410 displays the average coverage rate of printed materials printed by the device with which userA is under contract for a service plan, and the upper limit coverage rate predefined in the service plan. The UI screen 410 displays a title 411 of the UI screen, a period 412, a description 413, a current coverage rate 414, and a message 415.

The title 411 of the UI screen is an area where the title of the UI screen 410 is displayed, and in the example of FIG. 4, the displayed title indicates that the UI is about coverage rate information of DeviceA. In the period 412, the start date and end date of the print history based on which the average coverage rate is calculated are displayed, with the start date displayed to the left of the hyphen and the end date displayed to the right of the hyphen. The start date and end date of the period 412 can be changed and set within the contract period. That is, it can also be said that the screen information described above includes information representing a screen for displaying the contract period of the service used by the user.

The description 413 is a description of the displayed coverage rates, with the average coverage rate of the printed materials that have been printed to the left of the slash and the upper limit value of the coverage rate predefined in the print service to the right of the slash.

In the current coverage rate 414, the average coverage rate of the printed materials printed by userA using DeviceA and the upper limit value of the coverage rate predefined in planA are displayed. In the current coverage rate 414, the average coverage rate of the printed materials printed by userA using DeviceA is displayed to the left of the slash, and the upper limit value of the coverage rate predefined in planA is displayed to the right of the slash.

In the message 415, a sentence to be communicated to userA, i.e., the sentence of a glossary selected by the statistic information generating unit 326 based on the conditions of the glossary table shown in Table 5, is displayed. That is, it can also be said that the screen information described above includes information representing a screen for displaying a message corresponding to the relationship between the coverage rate and the threshold value.

### (Flow of Processing Among Apparatuses)

FIG. 5 is a sequence diagram showing the flow of processing among apparatuses. FIG. 5 shows an example of a sequence in which a user signs up for a contract of a print service, and then information on the average coverage rate, which is a piece of statistic information regarding the results of printing that has been performed during the contract, is obtained.

In S501, the user with user ID userA performs user registration in the print server 103 via the client terminal 102. In S501, the data transmission/reception unit 321 of the client terminal 102 of userA transmits to the data transmission/reception unit 337 a user registration instruction including information for user registration, such as the user ID and password that are input via the user interface unit 324. In S502, the user management unit 332 saves the received user ID and password in the user management table shown in Table 1, which is saved in the data storage unit 331, and returns a user registration instruction result indicating that the user registration was successful to the client terminal 102.

In S503, the data transmission/reception unit 321 of the client terminal 102 of userA transmits to the data transmission/reception unit 337 the user ID and password that are input via the user interface unit 324. In S504, the user management unit 332 refers to the user management table shown in Table 1, which is saved in the data storage unit 331, to check whether the user ID and password match those of userA, and if they match, the user management unit 332 returns a login result indicating that the login was successful.

In S505, the user of userA signs up for a contract of a service plan for a print service. In S505, the data transmission/reception unit 321 of the client terminal 102 transmits to the data transmission/reception unit 337 a contract registration instruction including information for the contract, such as device information, service plan information, and contract period information that are input via the user interface unit 324. In S506, the contract management unit 333 saves the received contract information in the contract status management table shown in Table 3, which is saved in the data storage unit 331, and returns a contract registration instruction result indicating that the contract registration was successful.

Thereafter, in S507 to S513, processing related to printing by the image forming apparatus 101 using the print server 103 is executed repeatedly and asynchronously with the later-described processing of S514 to S517.

In S507, if the user of userA inputs a print instruction to the user interface unit 324, the print instruction unit 323 transmits the print instruction to the data transmission/reception unit 337 via the data transmission/reception unit 321. In S508, the data transmission/reception unit 337 of the print server 103 returns to the data transmission/reception unit 321 a notification indicating that the reception of the print instruction has been completed.

In S509, based on the print instruction received in S507, the electronic image forming unit 336 creates the electronic data of a print job to be transmitted to the image forming apparatus 101 as a print instruction. Then, the created electronic data of the print job (the print instruction data) is transmitted to the data transmission/reception unit 311 of the image forming apparatus 101. In S510, the data transmission/reception unit 311 of the image forming apparatus 101 returns to the data transmission/reception unit 337 a notification indicating that the reception of the print instruction data has been completed.

Note that, in the present embodiment, although a description is given of the example in which a print instruction is sent from the client terminal 102 to the image forming apparatus 101 via the print server 103, there is no such limitation. The print instruction may be sent directly from the data transmission/reception unit 321 of the client terminal 102 to the data transmission/reception unit 311 of the image forming apparatus 101.

In S511, the image forming apparatus 101 executes printing based on the print instruction received in S509. That is, the image forming apparatus 101 performs image formation.

In S512, the data transmission/reception unit 311 transmits a print result and log data to the data transmission/reception unit 337. Specifically, the date and time of the printing in S511, document information, the number of printing and paper (sheets), information on printing materials such as the toners and inks used, the coverage rate of the printing materials, sensor data of the image forming apparatus 101, etc., are transmitted to the data transmission/reception unit 337. The coverage rate of printing material is generated from the use amount of the printing material used in the print processing and the size of the paper. That is, it can also be said that the print server 103 obtains image formation information indicating the number of sheets on which an image is formed by the image forming apparatus 101 and the use amount of recording material used in the image formation. Note that the coverage rate may be generated by a method other than the above-described method. Further, in a case where printing fails in S511 due to a paper jam or the like, the coverage rate may result in 0%, or the printing may be excluded from the calculation targets of the average coverage rate, or the coverage rate may be calculated from the print processing until the failure.

In S513, the print history management unit 334 saves the received print result and log data in the print history management table shown in Table 4, which is saved in the data storage unit 331. Then, the data transmission/reception unit 337 of the print server 103 returns to the data transmission/reception unit 301 a notification indicating that the reception has been completed.

Thereafter, in S514 to S517, the processing related to obtainment of statistic information on the print results using the print server 103 is executed repeatedly and asynchronously with the above-described processing of S507 to S513. Statistic information may be obtained in S514 to S517 after the printing in S507 to S513 is executed only once, or statistic information may be obtained after the printing is performed multiple times. Further, obtainment of statistic information in S514 to S517 may be performed only once, or may be performed multiple times.

In S514, the user of userA makes a request to obtain statistic information on the print result corresponding to the print instruction executed in S507. In S514, if the user of userA inputs a request to obtain statistic information to the user interface unit 324, the data transmission/reception unit 321 transmits the request to obtain statistic information to the data transmission/reception unit 337.

In S515, the statistic information generating unit 335 of the print server 103 generates statistic information from the information managed by the user management unit 332, the contract management unit 333, and the print history management unit 334, and generates a UI screen for displaying the statistic information. In the present embodiment, information on a coverage rate and a UI screen are generated as statistic information.

### (Statistic Information Generation Process)

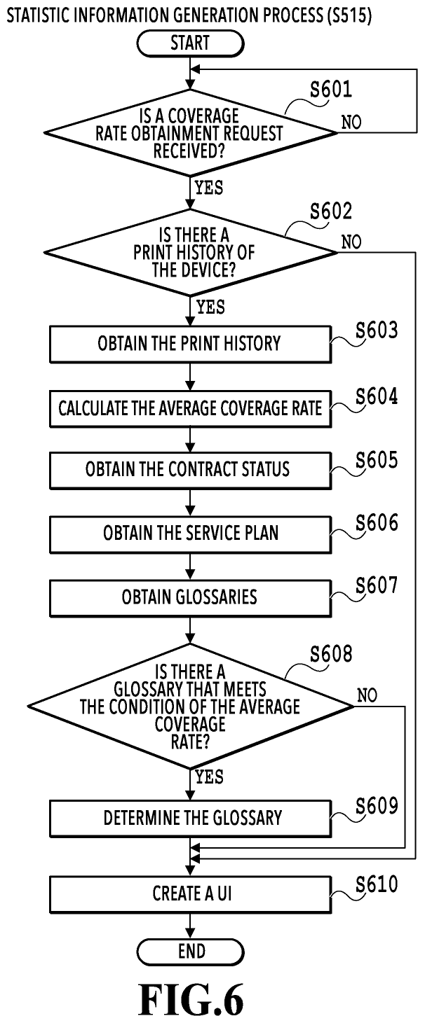

FIG. 6 is a flowchart showing the detailed flow of the statistic information generation process (S515).

In S601, the statistic information generating unit 335 determines whether input of an obtainment request for an average coverage rate, which is a piece of statistic information, is received from the client terminal 102. In a case where the statistic information generating unit 335 acquires a determination result indicating that input of an obtainment request for an average coverage rate, which is a piece of statistic information, is received from the client terminal 102 (YES in S601), the processing proceeds to S602. Note that, in a case where the determination result indicating that input of an obtainment request for an average coverage rate is received cannot be acquired (NO in S601), the processing of S601 will be repeatedly executed until the determination result indicating that input of an obtainment request for an average coverage rate is received is acquired.

In S602, the statistic information generating unit 335 determines whether the print history management table shown in Table 4, which is managed by the print history management unit 334, contains a print history of the device that is a target of the calculation of the coverage rate. In a case where a determination result indicating that there is no print history of the device in the print history management table (NO in S602) is acquired, the processing proceeds to S610. In a case where a determination result indicating that there is a print history of the device that is a target of the calculation of the coverage rate in the print history management table (YES in S602) is acquired, the processing proceeds to S603.

In S603, the statistic information generating unit 335 obtains the print history of the device that is a target of the calculation of the coverage rate from the print history management table shown in Table 4, which is managed by the print history management unit 334. In S604, the statistic information generating unit 335 calculates the average coverage rate from the coverage rates of the device history obtained in S603. That is, the average coverage rate corresponding to the use amount of printing material per predetermined number of sheets (one sheet) on which the image forming apparatus 101 has performed image formation during a predetermined period is calculated.

In S605, from the contract status management table shown in Table 3, which is managed by the contract management unit 333, the statistic information generating unit 335 obtains the contract status of the device that is a target of the calculation of the coverage rate, and obtains the plan ID of the service plan for which the device is under contract. In S606, the statistic information generating unit 335 obtains a list of service plans from the service plan management table shown in Table 2, which is managed by the contract management unit 333. From the list of service plans, service plan information of the plan ID obtained in S605, for which the device is under contract, is obtained. In S607, the statistic information generating unit 335 obtains a list of glossaries from the glossary table shown in Table 5, which is managed by the statistic information generating unit 335 itself.

In S608, whether the list of glossaries obtained in S607 contains a glossary that meets the condition of the average coverage rate calculated in S604 and the service plan information obtained in S606 is determined. In a case where a determination result indicating that there is no glossary that meets the condition is acquired (NO in S608), the processing transitions to S610. In a case where a determination result indicating that there is a glossary that meets the condition is acquired (YES in S608), the processing transitions to S609.

In S609, the statistic information generating unit 335 determines the glossary that meets the condition as the glossary to be used.

In S610, the statistic information generating unit 335 creates a UI screen related to the coverage rates to be provided to the user. Specifically, the statistic information generating unit 335 creates a UI screen corresponding to the processes that have been passed through.

### (UI to be Created)

FIG. 7A to FIG. 7C are diagrams illustrating examples of a UI created in the UI creation process. FIG. 7A shows a UI example of a case where the processing transitions from S602 to S610, FIG. 7B shows a UI example of a case where the processing transitions from S608 to S610, and FIG. 7C shows a UI example of a case where the processing transitions from S609 to S610.

In a case where the processing proceeds from S602 to S610, the statistic information generating unit 335 creates the UI 710 in which a section 711 corresponding to an average coverage rate and a section 712 corresponding to a glossary are left blank, as illustrated in FIG. 7A. This is because there is no print history, and therefore it is not possible to calculate an average coverage rate or determine a glossary.

In a case where the processing transitions from S608 to S610, the statistic information generating unit 335 creates the UI 720 in which only a section 721 corresponding to an average coverage rate is filled in with the average coverage rate, and a section 722 corresponding to a glossary is left blank, as illustrated in FIG. 7B. This is because, although there is a print history, there is no glossary that meets a condition.

In a case where the processing transitions from S609 to S610, the statistic information generating unit 335 creates the UI 730 as illustrated in FIG. 7C. That is, the UI 730 is created in which a section 731 of the UI corresponding to an average coverage rate is filled in with the average coverage rate and a section 732 corresponding to a glossary is filled in with the glossary determined in S609. This is because there is a print history and there is a glossary that meets a condition.

As described above, by executing the processing of S601 to S610, information related to coverage rates and a UI screen are generated in S515. That is, it can also be said that the statistic information generating unit 335 generates the UI screen data for displaying the use amount of recording material per predetermined number of sheets during a predetermined period and the upper limit use amount of the recording material per predetermined number of sheets under the contract for the subscription service.

In S516, the print server 103 returns the information related to the coverage rates and the UI screen created in S515 to the data transmission/reception unit 321. That is, it can also be said that the data transmission/reception unit 337 of the print server 103 outputs the UI screen data generated by the statistic information generating unit 335 to the client terminal.

In S517, the print service data display unit 325 displays the information related to the coverage rates and the UI screen received by the data transmission/reception unit 321 in S516.

Note that it is also possible to adopt a configuration in which, in a case where there are multiple pieces of statistic information provided by the print server 103, a request to obtain another piece of statistic information can be made from a UI screen displayed by the print service data display unit 325, thereby repeatedly executing the processes of S514 to S517 to display each piece of the statistic information.

As described above, in the present embodiment, the coverage rate of each printed material printed by the user during the contract period of a print service is saved, and the average coverage rates of those are notified to the user together with the upper limit values of the coverage rates predefined for the print service. This allows the user to grasp whether the user is complying with the predefinition of the print service. That is, it is possible for the user to grasp the use state of recording material determined in the service used.

### Second Embodiment

In the first embodiment, a method for notifying a user of an average coverage rate of printed material printed by the user during the contract period of a print service is described. However, it is conceivable that the user may also want to know the coverage rate for each print (each image formation), not only the average coverage rate.

In the present embodiment, a description is given of a mode in which, in addition to the average coverage rate, the coverage rate for each print is notified to the user. In the present embodiment, it is assumed that the user operating the client terminal 102 is the user of userA in the user ID column of Tables 1 and 3 in the first embodiment. The user of userA is a user who uses the image forming apparatus 101, and the image forming apparatus 101 is assumed to be the device of DeviceA in the device ID column of Tables 3 and 4 in the first embodiment. Further, it is assumed that the user of userA is under contract for a service plan with plan ID planA in Tables 2 and 3 of the first embodiment, and DeviceA is registered as the device to be used.

(UI Screen that Displays Coverage Rate Information)

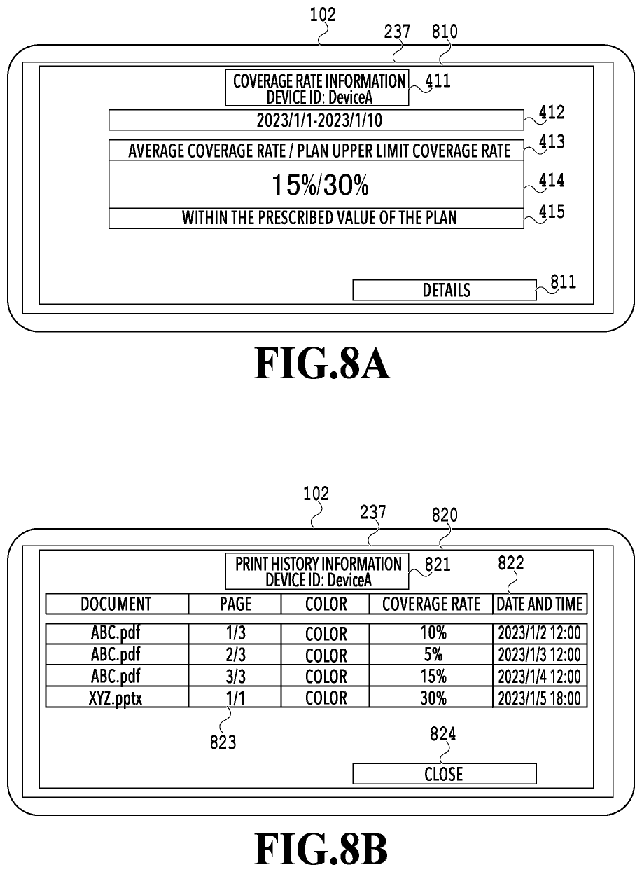

FIG. 8A and FIG. 8B are diagrams illustrating examples of a UI screen displaying coverage rate information according to the present embodiment. FIG. 8A, as in FIG. 4, shows a case of displaying an average coverage rate of printed material printed by a device under contract for a service plan, and the upper limit coverage rate predefined in the service plan. FIG. 8B shows a case of displaying a print history of printing performed by a device that is under contract for a service plan. FIG. 8B displays information on the coverage rate for each print as the print history. The UI screen 810 is generated by the statistic information generating unit 335 of the print server 103 according to the present embodiment.

The UI screen 810 is displayed on the display 237 of the client terminal 102 used by the user who has logged in with the user ID userA. The UI screen 810, as with the UI screen 410, displays the title 411 of the UI screen, the period 412, the description 413, the current coverage rate 414, and the message 415. The UI screen 810 further displays a details button 811.

The details button 811 is a button for transitioning the screen from the UI screen 810 of FIG. 8A to the UI screen 820 of FIG. 8B. If the details button 811 is pressed as a user operation, the UI screen is switched from the UI screen 810 illustrated in FIG. 8A to the UI screen 820 illustrated in FIG. 8B.

The UI screen 820 displays a title 821, a description 822, a table 823, and a close button 824. The UI screen 820 displays print history information indicating the print history of printing performed by a device with which userA is under contract for a service plan. On the UI screen 820, information on the average coverage rate for each printed page is displayed as the print history information.

The title 821 is the title of the UI screen, and indicates that the UI shows the print history information of DeviceA. The description 822 is a description of the display of the print history, and displays the name of each item of the print history table. The description of the name of each item is the same as that of the print history management table shown in Table 4 of the first embodiment. The table 823 is a print history table, and displays information for each page printed by the device under contract for a service plan. Note that it is also possible to display information for each print job. Specifically, the average coverage rate per page in one print job may be calculated and displayed. For example, since the three pages of the document “ABC.pdf” in the table 823 of FIG. 8B are printed in one print job, these three rows may be combined into one row and the coverage rate column may display their average value, which is 10%. The close button 824 is a button for transitioning the screen from the UI screen 820 illustrated in FIG. 8B to the UI screen 810 illustrated in FIG. 8A. If the close button 824 is pressed as a user operation, the UI screen is switched from the UI screen 820 illustrated in FIG. 8B to the UI screen 810 illustrated in FIG. 8A.

### (Flow of Processing Among Apparatuses)

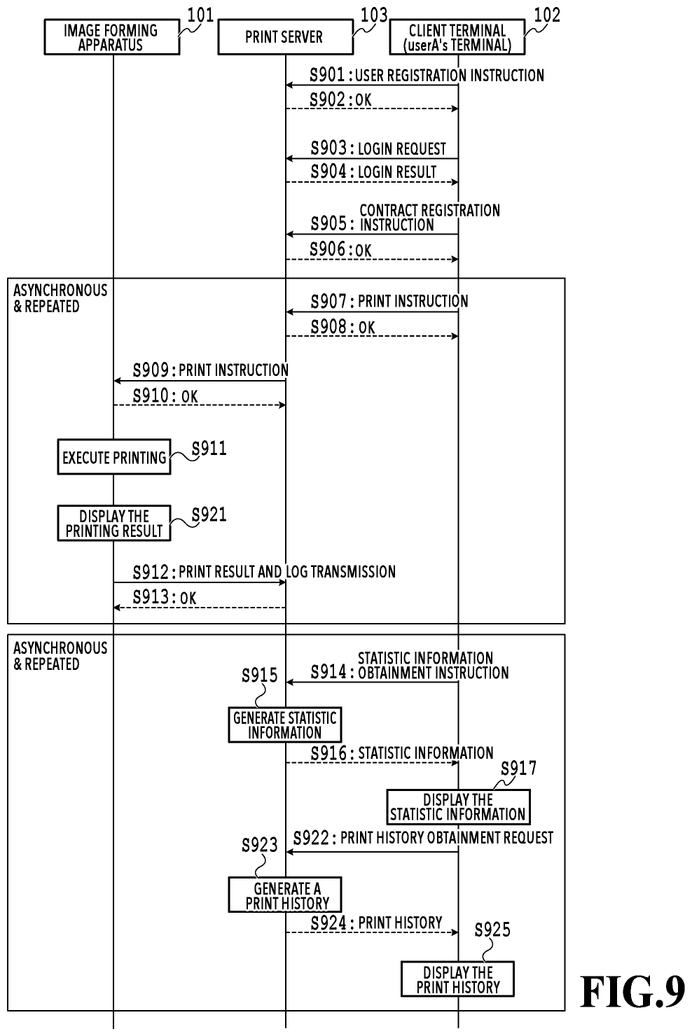

FIG. 9 is a sequence diagram showing the flow of processing among apparatuses. FIG. 9 shows an example of a sequence in which a user signs up for a contract of a print service, and then information on the average coverage rate and the coverage rate for each printed page, which are pieces of statistic information on the results of printing performed during the contract, is obtained. Note that S901 to S917 are the same processes as S501 to S517 of FIG. 5, and thus detailed descriptions thereof are omitted.

After the image forming apparatus 101 executes printing in S911, the processing proceeds to S921. In S921, the image forming apparatus 101 displays a coverage rate as a print result on the user interface unit 316. The user of userA is able to know the coverage rate for each print by checking the coverage rate displayed on the user interface unit 316. There are methods, such as the method described in Japanese Patent Laid-Open No. 2015-39782, for estimating the use amount of printing material used in printing before the printing is performed, and, since a coverage rate is a ratio of the use amount of printing material used for printing on paper, the coverage rate can also be estimated in a similar manner. Although the coverage rate is displayed in S921 after printing is executed in S911, the coverage rate may be estimated before the printing, so that an estimated coverage rate is thereby displayed before the printing is executed in S911.

### (UI Screen Displaying an Estimated Average Coverage Rate and an Upper Limit Coverage Rate)

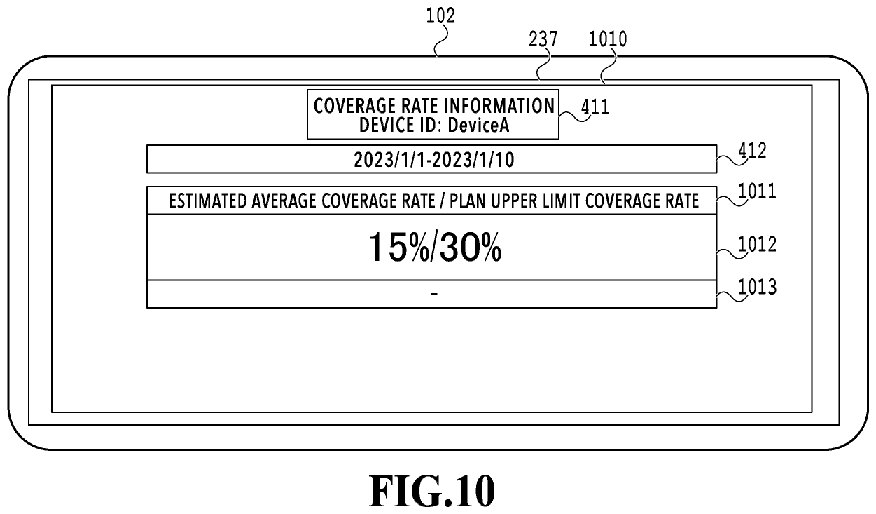

FIG. 10 is a diagram illustrating an example of a UI screen displaying an estimated average coverage rate and an upper limit coverage rate. The UI screen 1010 displays the title 411 of the UI screen and the period 412, as in the UI screen 410. The UI screen 1010 further displays a description 1011, a coverage rate 1012, and a message 1013.

The description 1011 displays an estimated average coverage rate/a plan upper limit coverage rate. The estimated average coverage rate indicates that the average coverage rate was obtained by estimation.

The coverage rate 1012 displays the estimated average coverage rate and the plan upper limit coverage rate. In the coverage rate 1012, the estimated average coverage rate is displayed to the left of the slash, and the upper limit value of the coverage rate predefined in planA is displayed to the right of the slash. In the message 1013, since there is no print history, the section corresponding to a glossary is left blank.

In S917, the print service data display unit 325 displays the information related to the coverage rates and the UI screen received by the data transmission/reception unit 321 in S916. Thereafter, in S922, the user of userA selects (presses) the details button 811 on the UI screen 810 as a user operation, thereby inputting a request to obtain the print history to the user interface unit 324. As a result, the data transmission/reception unit 321 transmits the request to obtain the print history to the data transmission/reception unit 337.

In S923, the statistic information generating unit 335 obtains the print history of the device from the print history management table shown in Table 4 of the first embodiment, which is managed by the print history management unit 334, and creates the UI screen 820 that displays the print history. In S924, the print server 103 returns the UI screen 820 displaying the print history, which is created in S923, to the data transmission/reception unit 321.

In S925, the print service data display unit 325 displays the UI screen 820 displaying the print history information received by the data transmission/reception unit 321 in S924.

As described above, in the present embodiment, the average coverage rate estimated at the time the user performed printing and the upper limit coverage rate are notified to the user. Further, the average coverage rate of each printed material is saved, and the print history of those is notified to the user. These notifications allow the user to grasp the average coverage rate for each print.

### Third Embodiment

In the first embodiment, a description is given about a method in which an average coverage rate of printed material printed by the user during the contract period of a print service is notified to the user together with the upper limit value of the coverage rate predefined in the print service. Although this method enables the user to grasp whether he/she is complying with the predefinition of the print service, there is a possibility that the average coverage rate of printed material printed by the user may exceed the upper limit value predefined in the print service.

In the present embodiment, a description is given of a method in which, in a case where the average coverage rate of printed material printed by the user exceeds the upper limit value of the coverage rate predefined in a print service, the contract will be changed to a service plan with a higher upper limit value of the coverage rate.

In the present embodiment, it is assumed that the user operating the client terminal 102 is the user of userA in the user ID column of Tables 1 and 3 in the first embodiment. The user of userA is a user who uses the image forming apparatus 101, and the image forming apparatus 101 is assumed to be the device of DeviceA in the device ID column of Tables 3 and 4 in the first embodiment. Further, it is assumed that the user of userA is under contract for a service plan with plan ID planA in Tables 2 and 3 of the first embodiment, and DeviceA is registered as the device to be used.

Further, Table 7 below shows an example of the print history managed by the print history management unit 334 in the present embodiment. The descriptions of the respective columns in Table 7 are the same as those in Table 4.

TABLE 7
Print History Management Table

| Device ID | Document | Page | Color | Coverage Rate | Date and Time |
|---|---|---|---|---|---|
| DeviceA | ABC.pdf | 1/3 | Color | 40% | 2023 Jan. 2 12:00 |
| DeviceA | ABC.pdf | 2/3 | Color | 45% | 2023 Jan. 3 12:00 |
| DeviceA | ABC.pdf | 3/3 | Color | 55% | 2023 Jan. 4 12:00 |
| DeviceA | XYZ.pptx | 1/1 | Color | 60% | 2023 Jan. 5 18:00 |

### (Flow of Processing Among Apparatuses)

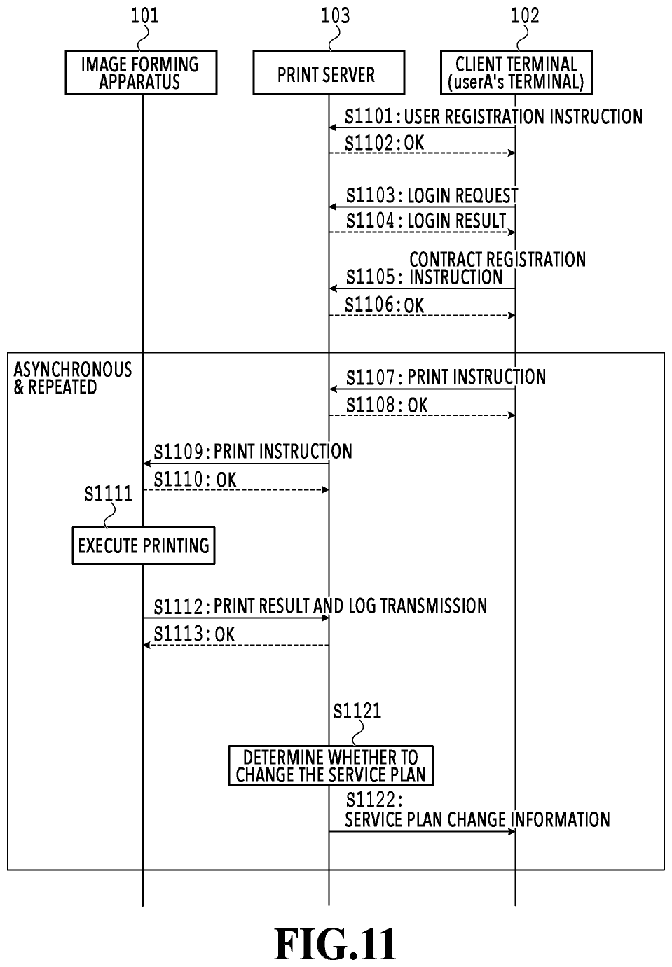

FIG. 11 is a sequence diagram showing the flow of processing among apparatuses. FIG. 11 shows an example of a sequence in which a user signs up for a print service, the average coverage rate of printed material printed during the contract exceeds the upper limit value of the coverage rate predefined in the print service, and then the contract is changed to a service plan that meets the condition. Note that S1101 to S1113 are the same processes as S501 to S513 of FIG. 5, and thus detailed descriptions thereof are omitted.

In S1112, the data transmission/reception unit 311 transmits a print result and log data to the data transmission/reception unit 337. That is, the print server 103 receives the print result transmitted from the image forming apparatus 101. In S1113, the print server 103 saves the print information (image formation information) received in S1112. Then, the data transmission/reception unit 337 of the print server 103 returns to the data transmission/reception unit 301 a notification indicating that the reception has been completed. After the process of S1113 ends, in S1121, the print server 103 determines whether to change the service plan and performs the change process. Note that it is assumed that the processes of S1107 to S1113, S1121, and S1122 are executed repeatedly.

### (Service Plan Change Determination Process)

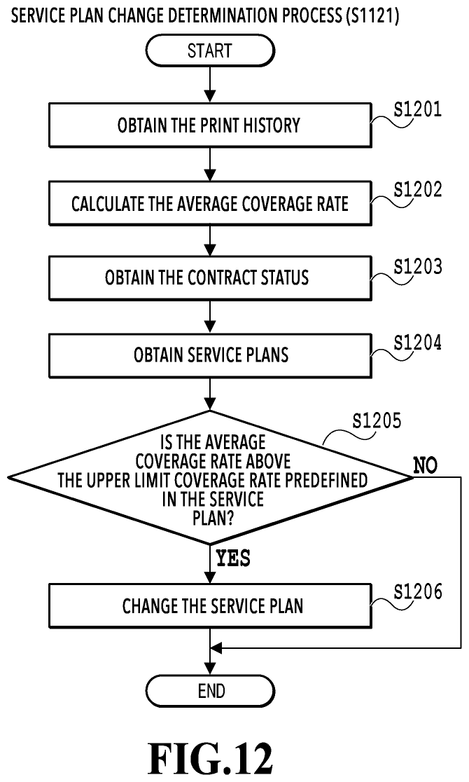

FIG. 12 is a flowchart showing the detailed flow of the service plan change determination process (S1121). Note that the service plan change determination process (S1121) is executed by the print server 103.

In S1201, the statistic information generating unit 335 obtains the print history of the device that is a target of the calculation of the coverage rate from the print history management table shown in Table 4, which is managed by the print history management unit 334. In S1202, the statistic information generating unit 335 calculates the average coverage rate from the coverage rates of the device history obtained in S1201.

In S1203, from the contract status management table shown in Table 3, which is managed by the contract management unit 333, the statistic information generating unit 335 obtains the contract status of the device that is a target of the calculation of the coverage rate, and the plan ID of the service plan for which the device is under contract. In S1204, the statistic information generating unit 335 obtains a list of service plans from the service plan management table shown in Table 2, which is managed by the contract management unit 333. Then, from the list of service plans, the statistic information generating unit 335 obtains service plan information of the plan ID obtained in S1203 for which the device is under contract.

In S1205, the statistic information generating unit 335 determines whether the average coverage rate calculated in S1202 is above the upper limit coverage rate of the service plan obtained in S1204. In a case where a determination result indicating that the average coverage rate is not above the upper limit coverage rate of the service plan is acquired (NO in S1205), the processing shown in FIG. 12 ends. In a case where a determination result indicating that the average coverage rate is above the upper limit coverage rate of the service plan is acquired (YES in S1205), the processing proceeds to S1206. In S1206, the print server 103 changes the service plan under contract. That is, the service plan is changed to a service plan that is predefined with an upper limit coverage rate that satisfies the average coverage rate.

In the present embodiment, the average coverage rate calculated in S1202 is 50% according to Table 7. Further, according to Table 2 and Table 3, the upper limit coverage rate of the service plan obtained in S1204 is 30%. Since the average coverage is 50% and the upper limit coverage rate of the service plan is 30% in the above-described present embodiment, the average coverage rate exceeds the upper limit coverage rate of the service plan, and thus the service plan is changed in the present embodiment. According to Table 2, the upper limit coverage rate of the service plan with plan ID planC is 60%, which is higher than the average coverage rate of 50% of the present embodiment, and thus the contract contents of userA are changed to the service plan planC. As described above, by carrying out the processes of S1201 to S1206, whether to change the service plan is determined and the change process is carried out in S1121.

Returning to the description of FIG. 11, in S1122, in a case where the service plan is changed in S1121, service plan change information indicating the service plans before and after the change, etc., is transmitted to the data transmission/reception unit 321. The data transmission in S1122 is performed by transmitting an email via an SMTP (Simple Mail Transfer Protocol) server or the like. This enables the user operating the client terminal to recognize that the service plan has been changed.

As described above, in the present embodiment, in a case where the average coverage rate of printed material printed by the user exceeds the upper limit value of the coverage rate predefined in the print service, the contract contents are changed to a service plan predefined with a higher upper limit value of the coverage rate. By carrying out such processing, the user can sign up for a contract of an appropriate service plan according to the status of coverage rates in printing.

### OTHER EMBODIMENTS

Although a case of using a coverage rate that predefines a use amount of printing material per sheet is described, there is no limitation as such. For example, a coverage rate that predefines a use amount of printing material per predetermined number of sheets, such as 3 sheets, 5 sheets, 10 sheets, 50 sheets, 100 sheets, etc., may be used. In a case where such coverage rates are used, the same functional effects as those described above are achieved.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to grasp the use state of recording material in light of the contract contents of the subscription service for which the user is under contract.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-081915, filed May 20, 2024, which is hereby incorporated by reference wherein in its entirety.

What is claimed is:

1. An information processing apparatus for providing a subscription service of an image forming apparatus to a user, the information processing apparatus comprising:
at least one memory that stores instructions; and
at least one processor that executes the instructions to:
obtain information indicating the number of sheets on which the image forming apparatus has performed image formation during a predetermined period and a use amount of printing material required for the image formation;
derive a use amount of the printing material per predetermined number of sheets, based on the obtained information; and
cause a client terminal used by the user to output UI screen data for displaying the derived use amount of the printing material per predetermined number of sheets and an upper limit use amount of the printing material per predetermined number of sheets under a contract for the subscription service.

2. The information processing apparatus according to claim 1,
wherein the UI screen data further displays a message corresponding to a relationship between the use amount of the printing material and the upper limit use amount of the printing material.

3. The information processing apparatus according to claim 1,
wherein, in a case where the use amount of the printing material is below a value obtained by multiplying the upper limit use amount of the printing material by a predetermined rate, the UI screen data further displays a message indicating that the use amount of the printing material is within the upper limit use amount of the printing material.

4. The information processing apparatus according to claim 1,
wherein, in a case where the use amount of the printing material is equal to or above a value obtained by multiplying the upper limit use amount of the printing material by a predetermined rate and, in addition, is equal to or below the upper limit use amount of the printing material, the UI screen data further displays a message indicating that the use amount of the printing material is about to exceed the upper limit use amount of the printing material.

5. The information processing apparatus according to claim 1,
wherein, in a case where the use amount of the printing material is above the upper limit use amount of the printing material, the UI screen data further displays a message indicating that the use amount of the printing material has exceeded the upper limit use amount of the printing material.

6. The information processing apparatus according to claim 1,
wherein, in a case where the use amount of the printing material is below a value obtained by multiplying the upper limit use amount of the printing material by a predetermined rate and, in addition, a use amount of the printing material per predetermined number of sheets during a predetermined period in the past is below the value obtained by multiplying the upper limit use amount of the printing material by the predetermined rate,
the UI screen data further displays a message indicating that the use amount of the printing material is equal to or below the upper limit use amount of the printing material.

7. The information processing apparatus according to claim 1,
wherein, in a case where the use amount of the printing material is equal to or above a value obtained by multiplying the upper limit use amount of the printing material by a predetermined rate and, in addition, is equal to or below the upper limit use amount of the printing material, or
in a case where the use amount of the printing material is below the value obtained by multiplying the upper limit use amount of the printing material by the predetermined rate and, in addition, the use amount of the printing material per predetermined number of sheets during a predetermined period in the past is equal to or above the value obtained by multiplying the upper limit use amount of the printing material by the predetermined rate,
the UI screen data further displays a message indicating that the use amount of the printing material is about to exceed the upper limit use amount of the printing material.

8. The information processing apparatus according to claim 1,
wherein the UI screen data further displays the use amount of the printing material per predetermined number of sheets each time the image formation is performed.

9. The information processing apparatus according to claim 1,
wherein the at least processor further executing the instructions to change the contents of the contract of the subscription service for which the user is under contract,
wherein, in the changing, in a case where the use amount of the printing material exceeds the upper limit use amount of the printing material, the contents of the contract are changed to contents that is predefined with an upper limit use amount of the printing material higher than the use amount of the printing material.

10. The information processing apparatus according to claim 1,
wherein the UI screen data further displays a period to which the obtained information belongs.

11. The information processing apparatus according to claim 1,
wherein the predetermined period is a contract period of the subscription service for which the user is under contract.

12. A control method of an information processing apparatus for providing a subscription service of an image forming apparatus to a user, the control method comprising:
obtaining information indicating the number of sheets on which the image forming apparatus has performed image formation during a predetermined period and a use amount of printing material required for the image formation;
deriving a use amount of the printing material per predetermined number of sheets, based on the obtained information; and
causing a client terminal used by the user to output UI screen data for displaying the derived use amount of the printing material per predetermined number of sheets and an upper limit use amount of the printing material per predetermined number of sheets under a contract for the subscription service.

13. A non-transitory computer readable storage medium storing a program for causing a computer to perform a control method of an information processing apparatus for providing a subscription service of an image forming apparatus to a user, the control method comprising:
obtaining information indicating the number of sheets on which the image forming apparatus has performed image formation during a predetermined period and a use amount of printing material required for the image formation;
deriving a use amount of the printing material per predetermined number of sheets, based on the obtained information; and
causing a client terminal used by the user to output UI screen data for displaying the derived use amount of the printing material per predetermined number of sheets and an upper limit use amount of the printing material per predetermined number of sheets under a contract for the subscription service.
